(19) United States
(12) Patent Application Publication
(10) Pub. No.: US 2020/0345004 A1
(43) Pub. Date: Nov. 5, 2020

(54) USE OF NATURAL OILS AND THEIR DERIVATIVES IN AGRICULTURAL FORMULATIONS

(71) Applicant: Ingevity South Carolina, LLC, North Charleston, SC (US)

(72) Inventors: Guigui Wan, North Charleston, SC (US); Qi Wang, North Charleston, SC (US)

(21) Appl. No.: 16/864,625

(22) Filed: May 1, 2020

Related U.S. Application Data
(60) Provisional application No. 62/940,432, filed on Nov. 26, 2019.
(60) Provisional application No. 62/842,605, filed on May 3, 2019.

(51) Int. Cl. A01N 37/10

(52) U.S. Cl. CPC A01N 37/10

(57) ABSTRACT

An agricultural formulation comprising an active component comprising a pesticide, a fungicide, an herbicide, or a combination thereof; a natural oil solvent; and a non-ionic surfactant.

### CROSS REFERENCE TO RELATED APPLICATIONS

This application claims the benefit of U.S. Provisional Application No. 62/842,605, filed May 3, 2019 and U.S. Provisional Application No. 62/940,432, filed Nov. 26, 2019, which are incorporated herein by reference in their entirety.

### BACKGROUND

### 1. Field of the Discovery

The present disclosure, in various embodiments, relates generally to the use of natural oils, e.g., distilled tall oil, esters of tall oil fatty acids, esters of soybean oil fatty acids, esters of dehydrogenated rosins, rosin acids, rosin esters, rosin oils, polyterpenes, vegetable oils, nut oils, seed oil fatty acids, palm oil, coconut oil, etc., or a combination thereof in emulsifiable concentrate formulations.

### 2. BACKGROUND INFORMATION

Liquid sprayable formulations, e.g., insecticide formulations, are commonly formulated as emulsifiable concentrates (EC). Because of their low water solubility, conventional EC formulations of pesticides such as pyrethroids include greater than 50 weight percent (wt %) solvent, specifically, volatile organic compounds (VOC), such as petroleum-derived aromatic and aliphatic solvents. These solvents can potentially pose health and safety concerns for applicators, pose environmental/regulatory concerns, and can cause minor to severe phytotoxicity in crops. Therefore, there is a need for agricultural formulations that do not contain petroleum-derived aromatic and aliphatic solvents.

Accordingly, it is desirable to have agricultural formulations wherein volatile organic compounds are minimized or eliminated, thus providing a more environmentally friendly and safer formulation.

### SUMMARY

Presently described are emulsifiable concentrate formulations, e.g., agricultural formulations, and methods of their use. It was surprisingly and unexpectedly discovered that emulsifiable concentrate formulations, e.g., agricultural formulations, could be prepared that result in the stable dispersion of the solute while minimizing or eliminating volatile organic compounds.

Thus, in an aspect, the disclosure provides an emulsifiable concentrate formulation comprising an active component to be dispersed, a natural oil solvent, and a non-ionic surfactant. In certain embodiments, the disclosure provides an agricultural formulation comprising an active component comprising a pesticide, a fungicide, an herbicide, or a combination thereof, a natural oil solvent, and a non-ionic surfactant. In certain embodiments, the disclosure provides an agricultural formulation further comprising a green co-solvent.

In other aspects, the disclosure provides methods of making and methods of using an emulsifiable concentrate formulation as described herein. For example, in certain embodiments, the disclosure provides a method of using an emulsifiable concentrate formulation as described herein comprising the steps of providing an emulsifiable concentrate formulation including an effective amount of an active component, e.g., a pesticide, a fungicide, an herbicide, or a combination thereof, and administering the emulsifiable concentrate formulation. In certain embodiments, the method comprises the step of administering or applying the emulsifiable concentrate formulation to soil, or a surface of a plant or an organism, e.g., an insect or pest, wherein the emulsifiable concentrate formulation effectuates the protection of the soil or plant from insects or pests, or effectuates the death of at least a portion, e.g., a substantial amount, of the insect or pests, or prevents damage from said insects or pests.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### DETAILED DESCRIPTION

The present disclosure now will be described more fully hereinafter, but not all embodiments of the disclosure are shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

### Exemplary Aspects and Embodiments

It was surprisingly and unexpectedly found that agricultural formulations including natural oils as solvents, in combination with a non-anionic surfactant were stable and remained in solution over several weeks and at varying temperatures. Advantageously, such formulations can minimize or eliminate the need for VOCs and semi-volatile organic compounds (SVOCs) in agricultural formulations. A further advantage of the disclosed formulations is hard water stability. In some regions, water rich in minerals, such as calcium and magnesium, is characterized as “hard water.” The water hardness presents great challenges to the formulators and farmers because of potential setting and precipitation issues. The disclosed formulations can minimize or eliminate these issues. Indeed, in the disclosed formulations, some embodiments have improved emulsion stability when compared to commercially available formulations, such as the bifenthrin EC formulation having a hydrocarbon solvent (BIFEN XTS, available from ADAMA).

As described above, prior conventional liquid agricultural formulations containing organic solvents suffer from well-known disadvantages, including risk of harm to sensitive plants and serve as sources of VOC and SVOC emissions. Organic solvents are commonly used in conventional formulations because pesticides are insoluble in water, but soluble in organic solvents. Therefore, there is a need for agricultural formulations that minimize or eliminate the need for organic solvents.

Thus, in an aspect, the description provides agricultural formulations comprising an active component including a pesticide, a fungicide, an herbicide, or a combination thereof; a natural oil solvent, and a non-ionic surfactant.

In any of the aspects or embodiments described herein, when present, the pesticide can be any pesticide known in the art. The pesticide can be a carbamate, such as carbaryl or methiocarb; an organophosphate, such as acephate, chlorpyrifos, malathion, or phosmet; a phenylpyrazole, such as fipronil; a pyrethroid, such as bifenthrin, cyfluthrin, fenpropathrin, fluvalinate, lambda-cyhalothrin, or permethrin; a botanical, such as a pyrethrin; a neonicotinoid, such as acetamiprid, dinotefuran, imidacloprid, or thiamethoxam; a butenolide such as flupyradifurone; a spinosyn, such as spinosad; a glycoside, such as abamectin; an avermectin, such as emamectin benzoate or milbemectin; a juvenile hormone mimic, such as s-Kinoprene or fenoxycarb; a pyridine-insect growth regulator, such as pyriproxyfen; a pyridine azomethine such as pymetrozine or pyrifluquinazon; a tetrazine, such as clofentezine; a thiazolidinones, such as hexythiazox; a 2,4-diphenyloxazoline derivative, such as etoxazole; a biopesticide, such as Bacillus thuringiensis kurstaki or Bacillus thuringiensis israelensis; an organotin miticides, such as fenbutatin-oxide; a pyrroles, such as chlorfenapyr; a benzolureas-insect growth regulator, such as diflubenzuron or novaluron; a buprofezin, such as buprofezin; a cyromazine-insect growth regulator, such as cyromazine; a diacylhydrazine, such as tebufenozide, methoxyfenozide; a trifluromethyl aminohydrazone, such as hydramethylnon; a carbazate, such as bifenazate; a napthoquinone derivative, such as acequinocyl; a METI acaricides and insecticides such as pyridaben, fenpyroximate, tolfenpyrad, fenazaquin; a semicarbazone, such as metaflumizone; a tetronic acid, such as spiromesifen; a tetramic acid, such as spirotetramat; a beta-ketonitrile, such as cyflumetofen; an anthranillic diamide, such as cyantraniliprole; a pyridine carboxamide such as flonicamid; a biopesticide insect growth regulator, such as azadirachtin; a pyridalyl, such as pyridalyl; a biopesticide, such as Beauveria bassiana, isaria fumosorosea Apopka strain 97(ATCC20874), steinernema felitae, steinernema carpocapsae; an oil, such as botanical oil, a clarified hydrophobic extract of neem oil, mineral oil, or petroleum; a soap, such as potassium salts of fatty acids; a pyrethrin and an oil, such as pyrethrins and canola oil; a pyrethrin, such as pyrethrin and piperonyl butoxide; an organophosphate and pyrethroid, such as chlorpyrifos and cyfluthrin; a pyrethroid and neonicotinoid, such as cyfluthrin and imidacloprid; a glycoside and carbazate, such as abamectin and bifenazate. In preferred embodiments, the pesticide is a pyrethroid. Exemplary pyrethroids include bifenthrin, pendimethalin, permethrin, resmethrin, allethrin, cypermethrin, deltamethrin, and sumithrin. In certain embodiments, the pesticide is neem oil.

In any of the aspects or embodiments described herein, when present, the fungicide can be any fungicide known in the art. The fungicide can include, for example, azoxystrobin, bifujunzhi, coumethoxystrobin, coumoxystrobin; dimoxystrobin, enestroburin, enoxastrobin, fenaminstrobin, fenoxystrobin, flufenoxystrobin, fluoxastrobin, jiaxiangjunzhi, kresoxim-methyl, mandestrobin, metominostrobin, orysastrobin, picoxystrobin, pyraclostrobin, pyrametostrobin, pyraoxystrobin, triclopyricarb, trifloxystrobin, methyl 2-[2-(2,5-dimethylphenyloxymethyl)phenyl]-3-methoxyacrylate, pyribencarb, triclopyricarb/chlorodincarb, famoxadon, fenamidon, cyazofamid, amisulbrom, benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthio-biphenyl-2-yl)-3-difluoromethyl-1-methyl-1H-pyr-azole-4-carboxamide, N-(2-(1,3,3-trimethylbutyl)phenyl)-1,3-dimethyl-5-fluoro-1H-pyrazole-4-ca-rboxamide, N-[9-(dichloromethylene)-1,2,3,4-tetrahydro-1,4-methanonaphthal-en-5-yl]-3-(difluoromethyl)-1-methyl-H-pyrazole-4-carboxamide, diflumetorim, binapacryl, dinobuton, dinocap, meptyl-dinocap, fluazinam, ferimzone, ametoctradin, silthiofam, azaconazole, bitertanol, bromuconazole, cyproconazole, difenoconazole, diniconazole, diniconazole-M, epoxiconazole; fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, imazalil, pefurazoate, prochloraz, triflumizole, pyrimidines, fenarimol, nuarimol, pyrifenox, triforine, aldimorph, dodemorph, dodemorph acetate, fenpropimorph, tridemorph, fenpropidin, piperalin, spiroxamine, fenhexamid, benalaxyl, benalaxyl-M, kiralaxyl; metalaxyl, metalaxyl-M (mefenoxam), ofurace; oxadixyl, hymexazole, octhilinone, oxolinic acid, bupirimate, benomyl, carbendazim, fuberidazole, thiabendazole, thiophanate-methyl, 5-chloro-7-(4-methyl-piperidin-1-yl)-6-(2,4,6-trifluorophenyl)-[1,2,4]tri-azolo[1,5-a]pyrimidine, diethofencarb, ethaboxam, pencycuron, fluopicolid, zoxainid, metrafenon, pyriofenon, cyprodinil, mepanipyrim, pyrimethanil, fluoroimide, iprodione, procymidone, vinclozolin fenpiclonil, fludioxonil, quinoxyfen, edifenphos, iprobenfos, pyrazophos, isoprothiolane, dicloran, quintozene, tecnazene, tolclofos-methyl, biphenyl, chloroneb, etridiazole, dimethomorph, flumorph, mandipropamid, pyrimorph, benthiavalicarb, iprovalicarb, valifenalate and 4-fluorophenyl N-(1-(1-(4-cyanophenyl)ethanesulfonyl)but-2-yl)carbamate, propamocarb, propamocarb hydrochloride, ferbam, mancozeb, maneb, metiram, propineb, thiram, zineb, ziram, anilazine, chlorothalonil, captafol, captan, folpet, dichlofluanid, dichlorophen, flusulfamide, hexachlorobenzene, pentachlorophenol, phthalid, tolylfluanid, N-(4-chloro-2-nitrophenyl)-N-ethyl-4-methylbenzenesulfonamide, guanidine, dithianon, validamycin, polyoxin B, pyroquilon, tricyclazole, carpropamid, dicyclomet, fenoxanil, or a combination thereof.

In any of the aspects or embodiments described herein, when present, the herbicide can be any herbicide known in the art, such as, for example, acetochlor, acifluorfen, alloxydim, amidosulfuron, aminopyralid, atrazine, beflubutamid, bispyribac, butafenacil, cafenstrole, carfentrazone, chlorimuron, chlorotoluron, cinidon-ethyl, clethodim, clodinafop, clomazone, cloproxydim, clopyralid, cloransulam, cyanazine, cyclosulfamuron, cycloxydim, cyhalofop, daimuron, dicamba, diclofop, diclosulam, diflufenican, dimethenamid, diquat, dithiopyr, diuron, ethalfluralin, fenoxaprop, flazasulfuron, florasulam, fluazifop, flucarbazone, flufenacet, flufenican, flufenpyr, flumetsulam, flumiclorac, flumioxazin, fluroxypyr, fluthiacet, fomesafen, foramsulfuron, glufosinate, glyphosate, halosafen, halosulfuron, haloxyfop, imazamethabenz, imazamox, imazapic, imazapyr, imazaquin, imazethapyr, imazosulfuron, iodosulfuron, ioxynil, isoxaben, isoxaflutole, lactofen, linuron, mefenacet, mefluidide, mesosulfuron, mesotrione, metamifop, metazachlor, metosulam, metribuzin, MSMA, napropamide, nicosulfuron, norflurazon, oryzalin, oxadiazon, oxyfluorfen, paraquat, pebulate, pendimethalin, penoxsulam, picloram, picolinafen, pinoxaden, primisulfuron, profoxydim, propanil, pyraflufen, pyrazosulfuron, pyribenzoxim, pyriminobac, pyrithiobac, pyroxasulfone, pyroxsulam, quinclorac, quinmerac, quizalofop, rimsulfuron, sethoxydim, simazine, sulcotrione, sulfentrazone, sulfometuron, tefuryltrione, tembotrione, tepraloxydim, terbacil, thiazopyr, thidiazuron, thiencarbazone, thifensulfuron, thiobencarb, topramezone, tralkoxydim, triasulfuron, tribenuron, triclopyr, trifloxysulfuron, trifluralin, triflusulfuron, tritosulfuron, or a combination thereof.

The agricultural formulation may comprise an active component in an amount ranging from about 1 to about 50 wt %, about 1 to about 45 wt %, about 1 to about 40 wt %, about 1 to about 35 wt %, about 1 to about 30 wt %, about 1 to about 25 wt %, about 1 to about 20 wt %, about 1 to about 15 wt %, about 1 to about 10 wt %, about 1 to about 5 wt %, about 5 to about 50 wt %, about 5 to about 45 wt %, about 5 to about 40 wt %, about 5 to about 35 wt %, about 5 to about 30 wt %, about 5 to about 25 wt %, about 10 to about 50 wt %, about 10 to about 45 wt %, about 10 to about 40 wt %, about 10 to about 35 wt %, about 10 to about 30 wt %, about 10 to about 25 wt %, about 15 to about 50 wt %, about 15 to about 45 wt %, about 15 to about 40 wt %, about 15 to about 30 wt %, or from about 15 to about 25 wt %. In some embodiments, the active component can be present at about 5 wt % about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, or about 50 wt % of the total weight of the agricultural formulation.

The agricultural formulation includes a natural oil solvent. Natural oils and their derivatives have been used as adjuvants in agricultural formulations, such as distilled tall oil (DTO), tall oil fatty acids (TOFA), soybean oil fatty acids (SOFA), palm oil, coconut oil, and the like. However, natural oils have not be used as solvents in conventional formulations. Therefore, it was surprising and unexpected that an agricultural formulation that includes a natural oil as a solvent and minimizes or eliminates the use of conventional organic solvents would provide a suitable formulation. In some embodiments, the formulation includes no added organic solvent.

The natural oil solvent may be an ester of tall oil fatty acid, C₁-C₅ ester of soybean oil fatty acid, a rosin oil, a rosin C₁-C₃ ester, a distilled tall oil, a C₁-C₃ of a hydrogenated rosin, vegetable oil, safflower oil, sesame oil, canola oil, olive oil, polyterpene, or a combination thereof. The natural oil solvent may be a C₁-C₃ ester of tall oil fatty acid, C₁-C₅ ester of a soybean oil fatty acid, a rosin oil, a rosin C₁-C₃ ester, a polyterpene, a C₁-C₃ methyl ester of hydrogenated resin, a distilled tall oil, or a combination thereof. Exemplary TOFA esters include a methyl ester, for example POLYFAC TE-110, available from INGEVITY; butyl ester, for example, JONREZ FE-110, available from INGEVITY; or a pentaerythritol (PE) ester, for example POLYFAC TE-319, available from INGEVITY. Exemplary esters of soybean oil fatty acids include a methyl ester of a soybean oil fatty acid, for example, SOYGOLD, available from AGP. Exemplary rosin esters include a rosin methyl ester. Suitable C₁-C₃ esters of a hydrogenated rosin include a methyl ester of a hydrogenated rosin (100% rosin), available as HERCOLYN D, available from PINOVA.

In certain embodiments, natural oil solvents having a higher rosin content may provide more stable formulations than natural oil solvents having a lower rosin content. The rosin content of the natural oil solvent may be greater than about 30%, greater than about 35%, greater than about 40%, greater than about 45%, greater than about 50%, from about 30 to about 90%, from about 40 to about 80%, or from about 50 to about 75%.

In some embodiments, the natural oil solvents having a lower rosin content may provide formulations with lower viscosity than formulations having higher rosin content, providing for ease of use and application. The rosin content may be less than about 50%, less than about 45%, less than about 40%, less than about 35%, less than about 30%, less than about 25%, less than about 20%, from about 5 to about 50%, from about 10 to about 50%, from about 5 to about 45%, from about 10 to about 45%, from about 5 to about 40%, from about 10 to about 40%, from about 5 to about 35%, from about 10 to about 35%, from about 5 to about 30%, from about 10 to about 30%, from about 5 to about 20%, or from about 10 to about 20%.

The natural oil solvent is present from about 20 to about 80 wt %, about 20 to about 70 wt %, about 20 to about 60 wt %, about 20 to about 50 wt %, about 20 to about 40 wt %, about 20 to about 30 wt %, 25 to about 80 wt %, about 25 to about 70 wt %, about 25 to about 60 wt %, about 25 to about 50 wt %, about 25 to about 40 wt %, 30 to about 80 wt %, about 30 to about 70 wt %, about 30 to about 60 wt %, about 30 to about 50 wt %, about 30 to about 40 wt %, 40 to about 80 wt %, about 40 to about 70 wt %, or about 40 to about 60 wt %, based on the total weight of the agricultural formulation.

Although it is desirable to minimize or eliminate organic solvents from the disclosed agricultural formulations, depending on the active component loading and the natural solvent composition (for example, the rosin content of distilled tall oils), the formulation may become highly viscous, which may reduce the flowability and practical applicability of the formulation. An organic solvent may be added to decrease the viscosity of the agricultural formulation. The term “organic solvent” as used herein, is a solvent different from natural oil solvents, thus excluding natural oils from the meaning of “organic solvent.” Non-limiting examples of organic solvents include: glycols, such as ethylene glycol, propylene glycol, monopropylene glycol, hexylene glycol; halogenated hydrocarbons, such as dichloromethane and dichloroethane; polar aprotic solvents, such as acetonitrile, N-methylpyrrolidone (NMP), and M-ethylpyrrolidone (NEP), N-octylpyrrolidone, dimethylacetamide (DMA), dimethylformamide (DMF), dimethyl sulfoxide (DMSO), monomethylacetamide, hexamethylphosphoric triamide (HIVIPT); ethers, such as tetrahydrofuran (THF) and dimethyl ether; aliphatic hydrocarbons, such as paraffin and mineral oils; aromatic hydrocarbons, such as alkyl benzenes, for example, xylene, phenylxylyl ethane, alkyl naphthalenes; and gamma-butyrolactone, cyclohexanone, and dimethylimidazolidinone. In some embodiments, the organic solvent includes C₁₁-C₁₆ cyclic and aromatic hydrocarbons, commercially available as AROMATIC ND200 (EXXON). The organic solvent may be present in an amount ranging from about 1 to about 50 wt %, from about 5 to about 50 wt %, from about 5 to about 45 wt %, from about 5 to about 40 wt %, from about 5 to about 35 wt %, from about 5 to about 30 wt %, from about 5 to about 25 wt %, from about 5 to about 20 wt %, from about 5 to about 15 wt %, from about 5 to about 10 wt %, less than about 10 wt %, or less than about 5 wt %, based on the total weight of the agricultural formulation.

However, as discussed above, organic solvents suffer from well-known disadvantages, including risk of harm to sensitive plants and serve as sources of VOC and SVOC emissions. Therefore, it is desirable to minimize the amount of organic solvent used present in agricultural formulations. Advantageously, the inventors hereof have discovered that the combination of a natural oil solvent in combination with a green co-solvent can provide a formulation wherein the amount of organic solvent is minimized or eliminated. As used herein, the term “green co-solvent” refers to a solvent different from the natural oil solvent and the organic solvent. The green co-solvent can include a ketone solvent, an alcohol solvent, an organic acid solvent, an acetate solvent, a lactate solvent, a leveulinate solvent, or a combination thereof. In some embodiments, green co-solvent includes a C₃-C₈ ketone solvent, a C₁-C₆ alcohol solvent, C₂-C₁₀ carboxylic acid solvent a C₃-C₈ acetate solvent, a C₄-C₈ lactate solvent, a C₆-C₁₀ levulinate solvent, or a combination thereof. The green co-solvent can include acetone, methyl ethyl ketone, methyl isobutyl ketone, methanol, ethanol, 1-propanol, 2-propanol, 1-butanol, t-butanol, acetic acid, ethyl acetate, isopropyl acetate, propyl acetate, butyl acetate, isobutyl acetate, t-butyl acetate, methyl lactate, ethyl lactate, propyl lactate, isopropyl lactate, butyl lactate, isobutyl lactate, t-butyl lactate, methyl levulinate, ethyl levulinate, propyl levulinate, isopropyl levulinate, butyl levulinate, isobutyl levulinate, t-butyl levulinate, or a combination thereof.

A mixture of natural oil solvent and green co-solvent may be present in the formulation. The green co-solvent may be present from about 20 to about 80 wt %, about 20 to about 70 wt %, about 20 to about 60 wt %, about 20 to about 50 wt %, about 20 to about 40 wt %, about 20 to about 30 wt %, 25 to about 80 wt %, about 25 to about 70 wt %, about 25 to about 60 wt %, about 25 to about 50 wt %, about 25 to about 40 wt %, 30 to about 80 wt %, about 30 to about 70 wt %, about 30 to about 60 wt %, about 30 to about 50 wt %, about 30 to about 40 wt %, 40 to about 80 wt %, about 40 to about 70 wt %, or about 40 to about 60 wt %, based on the total weight of the agricultural formulation.

When the green co-solvent is present, a ratio of the weight of natural oil solvent to the weight green co-solvent may be from about 10:1 to about 1:10, or about 4:1 to about 1:4, about 3:1 to about 1:3, about 6:4 to about 4:6, about 2:1 to about 1:2, or about 1:1.

The agricultural formulations include a non-ionic surfactant. Surfactants are amphiphilic, having a structural group that has a very little attraction for water (a hydrophobic group) together with a group that has strong attraction for water (a hydrophilic group). Common to surfactants of different classes, the hydrophobic group can be a long-chain hydrocarbon. The hydrophilic group distinguishes surfactants of different classes: cationic, anionic, non-ionic, and amphoteric. The hydrophilic groups of anionic surfactants can be sulfonate, sulfate, or carboxylate groups, such as, for example, linear alkylbenzene sulfonate (LAS). The non-ionic surfactant may be any non-ionic surfactant known in the art. Mixtures of non-ionic surfactants may be used. In some embodiments, the non-ionic surfactant may be an ethylene oxide-co-propylene oxide, a castor oil ethoxylate, a polysorbate, nonylphenol ethoxylate, ethoxylated distilled tall oil, or a combination thereof. The non-ionic surfactant is present from about 5 to about 40 wt %, from about 5 to about 30 wt %, from about 5 to about 20 wt %, from about 10 to about 30 wt %, from about 10 to about 25 wt %, or from about 10 to about 20 wt %, based on the total weight of the composition.

The agricultural formulations may further comprise an additional surfactant comprising a cationic surfactant, an anionic surfactant, an amphoteric surfactant, or a combination thereof. In certain embodiments, the agricultural formulation includes an anionic surfactant in addition to the non-ionic surfactant. In an exemplary embodiment, the anionic surfactant is a linear alkylbenzene sulfonate. When present, the total wt % of the non-ionic surfactant and the additional surfactant is from about 5 to about 40 wt %, from about 5 to about 30 wt %, from about 5 to about 20 wt %, from about 10 to about 30 wt %, from about 10 to about 25 wt %, or from about 10 to about 20 wt %, based on the total weight of the agricultural formulation.

Examples of suitable additional surfactants include, but are not limited to: amidoamine surfactants; imidazolines; non-ionic surfactants; quaternary ammonium surfactants; triamines; tetra-amines; penta-amines; amidated tall oil derivatives, e.g., fatty acids or rosins, and others as well as their derivatives. Ionic surfactants which are suitable for use in the present disclosure include amphoteric surfactants, cationic surfactants, and combinations thereof.

As used herein the term “amphoteric surfactants” includes both mono-amphoteric and polyamphoteric surfactants. Amphoteric surfactants which are suitable for use in the present disclosure include, but are not limited to, the following: C-12 to C-24 (preferably C-16 to C-18) fatty acids, rosin acids, and combinations thereof modified with acrylic acid, maleic anhydride, fumaric acid, and/or other ene- and dieneophiles and further reacted with polyethylene polyamines, lithium C-12 to C-24 alkyl amidopropyl halide methyl carboxylate betaines, sodium C-12 to C-24 alkyl amidopropyl halide methyl carboxylate betaines, potassium C-12 to C-24 alkyl amidopropyl halide methyl carboxylate betaines, lithium C-12 to C-24 alkyl amidopropyl halide phosphate betaines, sodium C-12 to C-24 alkyl amidopropyl halide phosphate betaines, potassium C-12 to C-24 alkyl amidopropyl halide phosphate betaines, lithium C-12 to C-24 alkyl amidopropyl halide sulphate betaines, sodium C-12 to C-24 alkyl amidopropyl halide sulphate betaines, potassium C-12 to C-24 alkyl amidopropyl halide sulphate betaines. Unless the context indicates otherwise, the term “amphoteric surfactants” includes the above-noted compounds and their derivatives.

Useful anionic surfactants in the compositions described herein include but are not limited to petroleum sulfonates such as alpha-olefin sulfonates or sulfates, soap-type emulsifying agents, typically the alkali metal salts of higher (e.g., C6-C32) fatty acids, such as lauric, myristic, palimitic, oleic, ricinoleic and linoleic acids, or mixtures of acids available from animal or vegetable oils. Other examples of anionic surfactants are described in U.S. Pat. No. 4,282,037, the description of which is incorporated herein by reference. Additional anionic surfactants that may be included in the compositions described herein, include, e.g., water-soluble potassium salts of saturated or unsaturated higher (C6-C32) fatty acids, a sodium salt of a sulfuric acid ester of a higher alcohol, a sodium alkyl benzene sulfonate, a sodium salt of a dialkyl succinate sulfonic acid and a sodium salt of an alkyldiphenylether sulfonic acid. Of these, preferred are sodium alkyl benzene sulfonate, sodium lauryl sulfate, a polyoxethylene alkyl (or alkylphenyl)ether sulfonate and the likeA preferred surfactant is an anionic emulsifier such as lignate-surfactant blend (Indulin SA-L, MWV, Charleston Heights, S.C.). Unless the context indicates otherwise, the term “anionic surfactants” includes the above-noted compounds and their derivatives.

Cationic surfactants which are suitable for use in the compositions described herein include, but are not limited to, the following: fatty imidazolines derived from C-12 to C-24 fatty acids, fatty imidoamines derived from C-12 to C-24 (preferably C-16 to C-18) fatty acids, rosin acids, and combinations thereof modified with maleic anhydride, fumaric acid, and/or other ene- and dieneophiles and further reacted with polyalkylenepolyamines; fatty amidoamines derived from C-12 to C-24 (preferably C-16 to C-18) fatty acids, rosin acids and combinations thereof modified with acrylic acid, maleic anhydride, fumaric acid, and/or other ene- and dieneophiles and further reacted with polyalkylenepolyamines; saturated C-12 to C-24 alkyl monoamines, unsaturated C-12 to C-24 alkyl monoamines, saturated C-12 to C-24 alkyl polypropylenepolyamines; unsaturated C-12 to C-24 alkyl polypropylenepolyamines; saturated C-12 to C-24 alkyl monoamines modified by reaction with ethylene oxide and/or propylene oxide to give polyoxyethylene derivatives; unsaturated C-12 to C-24 alkyl monoamines modified by reaction with ethylene oxide and/or propylene oxide to give polyoxyethylene derivatives; saturated C-12 to C-24 alkyl polypropylenepolyamines modified by reaction with ethylene oxide and/or propylene oxide to give polyoxyethylene derivatives; unsaturated C-12 to C-24 alkyl polypropylenepolyamines modified by reaction with ethylene oxide and/or propylene oxide to give polyoxyethylene derivatives; saturated C-12 to C-24 alkyl aryl monoamines, unsaturated C-12 to C-24 alkyl aryl monoamines; saturated C-12 to C-24 alkyl aryl polypropylenepolyamines, unsaturated C-12 to C-24 alkyl aryl polypropylenepolyamines; C-12 to C-24 quaternary amines; C-12 to C-24 alkyl ether amines; C-12 to C-24 alkylether polyamines; C-12 to C-24 alkyl polypropylene polyamine N-oxides; amine derivatives of tannins, amine derivatives of phenolic resins; amine derivatives of lignins, amine-modified polyacrylates; and combinations thereof. In certain embodiments, the cationic surfactant is a member selected from the group consisting of saturated C-12 to C-24 alkyl monoamines, unsaturated C-12 to C-24 alkyl monoamines, saturated C-12 to C-24 alkyl polypropylenepolyamines, unsaturated C-12 to C-24 alkyl polypropylenepolyamines, and combinations thereof. In certain embodiments, the cationic surfactant is a blend of at least one member selected from the group consisting of saturated and unsaturated C-12 to C-24 alkyl monoamines with at least one member selected from the group consisting of saturated and unsaturated C-12 to C-24 alkyl polypropylenepolyamines. Unless the context indicates otherwise, the term “cationic surfactants” includes the above-noted compounds and their derivatives.

The agricultural formulation may comprise up to about 15 wt % bifenthrin; from about 65 to about 80 wt % solvent comprising a natural oil solvent, wherein the natural oil solvent is an ester of a tall oil fatty acid, C₁-C₅ ester of soybean oil fatty acid, rosin oil, a rosin C₁-C₃ ester, a distilled tall oil, a C₁-C₃ of a hydrogenated rosin, vegetable oil, safflower oil, sesame oil, canola oil, olive oil, a polyterpene, or a combination thereof; and from about 5 to about 20 wt % non-ionic surfactant.

The agricultural formulation may comprise from about 15 to about 30 wt % bifenthrin; from about 50 to about 80 wt % solvent comprising a natural oil solvent, wherein the natural oil solvent is a distilled tall oil comprising at least 50 wt % rosin, based on the total weight of the distilled tall oil, a C₁-C₃ ester of a tall oil fatty acid, a C₁-C₅ ester of soybean oil fatty acid, rosin oil, a polyterpene, a rosin C₁-C₃ ester, a methyl ester of hydrogenated rosin, or a combination thereof; and from about 5 to about 20 wt % non-ionic surfactant.

The agricultural formulation may include up to about 45 wt % of the active component; about 20 to about 60 wt % of the natural oil solvent, wherein the natural oil solvent is a tall oil fatty acid, a distilled tall oil, vegetable oil, safflower oil, sesame oil, canola oil, olive oil, or a combination thereof; and about 5 to about 30 wt % of the green co-solvent wherein the green co-solvent is n-butyl lactate.

An agricultural formulation typically includes active and inert ingredients. Active components include a pesticide, a fungicide, an herbicide or a combination thereof. Inert ingredients help deliver the active components to the target pest and enhance the utility of the pesticide. The agricultural formulations of the disclosure can include any inert ingredient useful in agricultural formulations, such as surfactants, dispersants, wetting agents; solvents different from the natural oil solvent, the organic solvent, and the green co-solvent; emulsifiers, defoamers, stabilizers, anti-microbial agents, anti-freeze agents, pigments, colorants, buffers, and the like.

Methods of preparing an agricultural formulation comprise admixing the pesticide, fungicide, herbicide, or a combination thereof and the natural oil solvent. In some embodiments, the active component is dissolved with stirring in the natural oil solvent with or without heat to form a homogenous solution. In certain embodiments, an organic solvent, a green co-solvent, or a combination thereof may be added.

Advantageously, the VOC and SVOC content of the agricultural formulations disclosed herein are minimized. As used herein, “VOC” refers to organic compounds with boiling points of up to about 200° C. As used herein, “SVOC” refers to organic compounds with boiling points from about 200° C. to about 400° C. The VOC content of the natural oil solvent may be less than about 1%. The SVOC content of the natural oil solvent may be less than about 1%. The sum of the VOC and the SVOC content of the natural oil solvent may be less than about 5%, less than about 4%, less than about 3%, less than about 2%, or less than about 1%.

The agricultural formulations of the present disclosure may be any liquid sprayable formulations known in the art. In some embodiments, an agricultural formulation is an emulsifiable concentrate. In other embodiments, an agricultural formulation is an oil dispersion (OD). In still other embodiments, an agricultural formulation is a suspo-emulsion (SE).

The color of the agricultural formulations were quantified using the Gardner color scale, which measures the “yellowness” of the formulation. The Gardner color refers to the neat color as measured by using a spectrophotometer according to the method ASTM D1544-04 (2010).

The disclosed agricultural formulations can have a Gardner color (neat) up to about 9.0, from about 1.0 to about 8.0, from about 1.0 to about 7.0, from about 1.0 to about 6.0, from about 1.0 to 5.0, from about 1.0 to about 4.5, from about 1.0 to about 4.0, from about 1.0 to about 3.5, from about 1.0 to about 3.3, from about 1.0 to about 2.0, from about 1.5 to about 4.0, from about 1.5 to about 3.5, from about 1.5 to about 3.0, from about 1.5 to about 2.5, or from about 1.5 to about 2.0.

In some embodiments, the viscosity of the formulation at 25° C. is from about 10 to about 500 centipoise (cP), from about 10 to about 400 cP, from about 10 to about 300 cP, from about 10 to about 250 cP, from about 10 to about 200 cP, from about 10 to about 150 cP, from about 10 to about 100 cP, from about 10 to about 50 cP, from about 10 to about 25 cP, or from about 10 to about 20 cP.

The agricultural formulations may have an emulsion droplet size (D50) measured using a dynamic light scattering (DLS) particle size analyzer ranging from about 1 to about 50 micrometers (μm), from about 1 to about 40 μm, from about 1 to about 30 μm, from about 1 to about 20 μm, from about 1 to about 10 μm, or from about 1 to about 5 μm.

The agricultural formulations may have a good emulsion stability determined by preparing a 1% emulsion in deionized (DI) water, allowing the emulsion to sit for 30 min, and observing whether the phases separated or if creaming occurred.

The surface tension for the agricultural formulations, measured using a Wilhelmy plate tensiometer, may range from about 30 to about 40 milliNewtons per meter (mN/m).

The rainfastness of the agricultural formulations, determined according to ASTM method STP1579 (“Evaluating the adhesion of new spreader-sticker adjuvants”), may range from about 10 to about 80%, from about 10 to about 70%, from about 10 to about 60%, from about 10 to about 50%, from about 10 to about 40%, from about 10 to about 30%, or from about 10 to about 20%.

In other aspects, the disclosure provides methods of making and methods of using an emulsifiable concentrate formulation as described herein. For example, in certain embodiments, the disclosure provides a method of using an emulsifiable concentrate formulation as described herein comprising the steps of providing an emulsifiable concentrate formulation including an effective amount of an agent, e.g., a pesticide, and administering the emulsifiable concentrate formulation. In certain embodiments, the method comprises the step of administering or applying the emulsifiable concentrate formulation to soil, or a surface of a plant or an organism, e.g., an insect or pest, wherein the emulsifiable concentrate formulation effectuates the protection of the soil or plant from insects or pests, or effectuates the death of at least a portion, e.g., a substantial amount, of the insect or pests, or prevents damage from said insects or pests.

The disclosure is further illustrated by the following examples, which are non-limiting.

### EXAMPLES

The materials used in the Examples are listed in Table 1.

TABLE 1

| Component | Description | Source |
|---|---|---|
| Bifenthrin | Bifenthrin | Qingdao Ocean |
| | | Import and |
| | | Export Co. |
| Tebuconazole | Tebuconazole | |
| Azoxystrobin | Azoxystrobin | |
| Prochloraz | Prochloraz | |
| Organic Solvent-1 | C₁₁-C₁₆ cyclic | EXXON |
| | and aromatic hydrocarbons, | |
| | available as Aromatic ND200 | |
| DTO-1 | C₁₆-C₂₉ fatty acids, | INGEVITY |
| | rosin acids, and sterols | |
| | (1% rosin content), | |
| | available as ALTAPYNE L1 | |
| DTO-2 | C₁₆-C₂₉ fatty acids, | INGEVITY |
| | rosin acids, and sterols | |
| | (5% rosin content), available | |
| | as ALTAPYNE L5 | |
| DTO-3 | C₁₆-C₂₉ fatty acids, | INGEVITY |
| | rosin acids, and sterols | |
| | (15% rosin content), available | |
| | as ALTAPYNE M15 | |
| DTO-4 | C₁₆-C₂₉ fatty acids, | INGEVITY |
| | rosin acids, and sterols | |
| | (28% rosin content), available | |
| | as ALTAPYNE 28B | |
| DTO-5 | C₁₆-C₂₉ fatty acids, | INGEVITY |
| | rosin acids, and sterols | |
| | (20% rosin content), available | |
| | as ALTAPYNE 226 | |
| DTO-6 | C₁₆-C₂₉ fatty acids, | INGEVITY |
| | rosin acids, and sterols | |
| | (50% rosin content), available | |
| | as ALTAPYNE M50 | |
| DTO-7 | C₁₆-C₂₉ fatty acids, | INGEVITY |
| | rosin acids, and sterols | |
| | (70% rosin content), available | |
| | as ALTAPYNE M70 | |
| SOFA-methyl ester | Methyl ester of soybean | AGP |
| | oil fatty acid | |
| | containing C₁₅-C₂₉ fatty acids, | |
| | rosin acids, and sterols, | |
| | available as SOYGOLD | |
| TOFA-methyl ester | Methyl ester of tall oil | INGEVITY |
| | fatty acid, available as | |
| | POLYFAC TE-110 | |
| Rosin-methyl ester | Rosin methyl ester | INGEVITY |
| Rosin Oil | Decarboxylated rosin | INGEVITY |
| Methyl ester of | Methyl ester of hydrogenated rosin | PINOVA |
| hydrogenated rosin | (100% rosin), available as HERCOLYN D | |
| Polyterpene | Available as deriphyllin | PINOVA |
| TOFA-butyl ester | Butyl ester of tall oil fatty acid, available as | INGEVITY |
| | JONREZ FE-100 | |
| TOFA-PE ester | Pentaerythritol ester of tall oil fatty acid, | INGEVITY |
| | available as POLYFAC TE319 | |
| NS-1 | Castor oil ethoxylate, available as SURFOM 360 | OXITENO |
| NS -2 | Ethylene oxide-co-propylene oxide, available as | DOW CHEMICAL |
| | ECOSURF EH-9 | |
| NS -3 | Nonylphenol ethoxylates, available as TERGITOL | DOW CHEMICAL |
| | NP10 | |
| NS -4 | Ethoxylated distilled tall oil | INGEVITY |
| NS-5 | Polysorbate-20, available as TWEEN-20 | Sigma Aldrich Chemical Co. |
| NS-6 | DTO (15% rosin), available as XTOL -3030 | INGEVITY |
| AS-1 | Alkyldiphenyloxide disulfonate, available as | DOW CHEMICAL |
| | DOWFAX 2A1 | |
| GS-1 | n-butyl lactate, available as PURASOLV BL | CORBION |

The Gardner color was measured with a ColorQuest XT spectrophotometer (HunterLab) using ASTM D1544-04 (2010) without dilution (neat).

Rainfastness was determined according to ASTM method STP1579 “Evaluating the adhesion of new spreader-sticker adjuvants.”

Viscosity was determined using a TA rheometer, tested with 25 s⁻¹ shear rate, 2 cm, 2-degree cone geometry at 20° C.

Emulsion droplet size (D50) was measured using a dynamic light scattering (DLS) particle size analyzer.

Emulsion stability was determined by preparing a 1% emulsion in DI water, allowing the emulsion to sit for 30 min, observing whether phases separated or if creaming occurred. A good emulsion stability means that neither phase separation nor creaming occurred.

The pH of each formulation was measured with a pH meter.

Percent mass loss was measured as follows. About 12 g formulation in an open 20 ml vial was placed in a fume hood at room temperature. After 2 days, the vial was weighed to determine mass loss. A high % mass loss correlates with a VOC.

Surface tension was measured using a Wilhelmy plate tensiometer.

Aging test, room temperature (RT): each formulation was allowed to sit at room temperature with a closed cap for 2 weeks.

Aging test, 54° C.: each formulation was allowed to sit in a 54° C. oven with closed cap for 2 weeks.

Freeze/thaw test: the formulation was chilled at −10° C. for 16 h, then allowed to sit at 25° C. for 8 h. This process was performed four times.

The details of the examples are contemplated as further embodiments of the described methods and compositions. Therefore, the details as set forth herein are hereby incorporated into the detailed description as alternative embodiments.

TABLE 2
Example No.

| | Units | E1 | E2 | E3 | E4 | E5 | E6 | E7 | *CE8 |
|---|---|---|---|---|---|---|---|---|---|
| Bifenthrin | wt % | 25 | 25 | 25 | 25 | 25 | 25 | 25 | 25 |
| NS-1 | wt % | 10 | 10 | 10 | 10 | 10 | 10 | 10 | |
| DTO-1 | wt % | 65 | 50 | | | | | | |
| Organic | wt % | | 15 | | 65 | | | | |
| Solvent-1 | | | | | | | | | |
| DTO-3 | wt % | | | 65 | | | | | |
| DTO-4 | wt % | | | | | 65 | | | |
| DTO-5 | wt % | | | | | | 65 | | |
| SOFA— | wt % | | | | | | | 65 | |
| methyl ester | | | | | | | | | |

Properties before aging

| | | | | | | | | | |
|---|---|---|---|---|---|---|---|---|---|
| Gardner | | 3.7 | 3.8 | 7.6 | 4.0 | 7.9 | 6.6 | 1.9 | 1.5 |
| Color | | | | | | | | | |
| Rainfastness | % | 41 ± 8 | 57 ± 19 | 29 ± 2 | 21 ± 4 | 36 ± 10 | 21 ± 3 | 22 ± 2 | 48 ± 10 |
| Viscosity | cP | 90 | 60 | 148 | 19 | 276 | 250 | 22 | 18 |
| Emulsion | μm | 16 | 4 | 6 | 15 | 2 | 3 | 50 | 4 |
| droplet size | | | | | | | | | |
| Emulsion | | | | | | | | | |
| stability, 1% | | Good | Good | Good | Good | Good | Good | Good | Good |
| pH | | 5.2 | 6.7 | 4.5 | 8.2 | 5.7 | 5.5 | 6.9 | 5.7 |
| Mass loss | wt % | 0 | 0 | 0 | 0.3 | 0 | 0 | NA | 9.2 |
| Surface | mN/m | 32.4 ± | 34.6 ± | 33.4 ± | 39.6 ± | 33.7 ± | 34.2 ± | 34.1 ± | 29.6 ± |
| tension | | 0.3 | 0.3 | 0.3 | 0.3 | 0.3 | 0.3 | 0.3 | 0.1 |

Properties after aging

| | | | | | | | | | |
|---|---|---|---|---|---|---|---|---|---|
| Emulsion | μm | 3 | 3 | 2 | 9 | 2 | 2 | 2 | NT |
| droplet size | | | | | | | | | |

Example No.

| | Units | E1 | E2 | E3 | E4 | E5 | E6 | E7 | *CE8 |
|---|---|---|---|---|---|---|---|---|---|
| Emulsion | | Good | Good | Good | Good | Good | Good | Good | NT |
| stability, 1% | | | | | | | | | |
| pH | | 4.8 | 5.5 | 4.4 | 6.6 | 5.6 | 5.4 | 7.4 | NT |
| Formulation | | Stable; | Stable; | Stable; | Stable; | Stable; | Stable; | Stable; | NT |
| appearance | | no phase | no phase | no phase | no phase | no phase | no phase | no phase | |
| after 54° C., | | separation | separation | separation | separation | separation | separation | separation | |
| 2 weeks | | or crystal | or crystal | or crystal | or crystal | or crystal | or crystal | or crystal | |
| | | growth | growth | growth | growth | growth | growth | growth | |
| Formulation | | Substantial | Stable; | Minor | Stable; | Minor | Minor | Stable; | NT |
| appearance | | crystal | no phase | crystal | no phase | crystal | crystal | no phase | |
| after 54° C./2 | | growth on | separation | growth on | separation | growth | growth | separation | |
| weeks, then | | bottom | or crystal | bottom | or crystal | on bottom | on bottom | or crystal | |
| RT/2 week | | | growth | | growth | | | growth | |

*CEx8 is a commercial product (available as Bifen XTS, from ADAMA) that includes 25.1% bifenthrin and 74.9% of inert ingredients.

Examples 1-7 show that at 25% bifenthrin loading and 10% non-ionic surfactant, all formulations were stable after 2 weeks at 54° C. However, after an additional two weeks at room temperature, crystal growth was observed for Examples 1, 3, 5, and 6, whereas no crystal growth was observed for Examples 2, 4, and 7. In Examples 1, 3, 5, and 6, the solvent was a DTO and aromatic ND200 was absent. Of the formulations wherein no crystal growth was observed, Examples 2 and 4 included a portion of the solvent as an organic solvent. Of Examples 1-7, Example 7 (methyl ester of SOFA) was the only formulation wherein no crystal growth was observed that did not contain organic solvent.

It was observed that solvents with higher rosin content reduced the formation of crystals (not shown). For example, at 25% bifenthrin loading, formulations of the selected non-ionic surfactants (NS-1 and NS-2) with either a low rosin content DTO solvents (DTO-1 and DTO-2), or a moderate rosin content DTO solvents (DTO-3, DTO-4, DTO-5, NS-6) (data not shown) did not result in stable formulations. Using a moderate rosin content DTO solvent (DTO-4, 28% rosin content), the impact of various non-ionic surfactants, (NS-1 though NS-5), and a combination of a non-ionic and anionic surfactant (NS-2 and AS-1) were tested (data not shown) to see if the choice of surfactant would improve stability. In all cases, crystal formation was observed.

TABLE 3
Example No.

| Component | Units | E8 | E9 | E10 | E11 | E12 | E13 | CE14 | CE15 | E16 | E17 | E18 |
|---|---|---|---|---|---|---|---|---|---|---|---|---|
| Bifenthrin | wt % | 25 | 25 | 25 | 25 | 25 | 25 | 25 | 25 | 25 | 25 | 25 |
| NS-2 | wt % | 10 | 10 | 10 | 10 | 10 | | 10 | | 10 | 10 | 10 |
| NS-1 | | | | | | | 10 | | 10 | | | |
| TOFA- | wt % | 65 | | | 32.5 | | | | | | | |
| methyl ester | | | | | | | | | | | | |
| Rosin Methyl | wt % | | | 65 | 32.5 | | | | | | | |
| Ester | | | | | | | | | | | | |
| Rosin Oil | wt % | | | | | 65 | 65 | | | | | |
| Organic | wt % | | | | | | | 65 | 65 | | | |
| Solvent-1 | | | | | | | | | | | | |
| DTO-6 | wt % | | | | | | | | | 65 | | |
| Methyl ester | wt % | | | | | | | | | | 65 | |
| of | | | | | | | | | | | | |
| hydrogenated | | | | | | | | | | | | |
| rosin | | | | | | | | | | | | |
| Polyterpene | wt % | | | | | | | | | | | 65 |
| SOFA methyl | wt % | | 65 | | | | | | | | | |
| ester | | | | | | | | | | | | |

For Examples 8-18, all formulations were stable initially and after four cycles of freeze/thaw. This shows that at 25% bifenthrin loading and 10% non-ionic surfactant, that TOFA methyl ester (Example 8), SOFA methyl ester (Example 9), rosin methyl ester (Example 10), a 50:50 mixture of rosin methyl ester and TOFA methyl ester (Example 11), rosin oil (Examples 12-13), methyl ester of hydrogenated rosin (Example 17), and polyterpene (Example 18), all provide formulations with stability comparable to formulations containing only organic solvent (Comparative Examples 14-15). As shown in Examples 12-13 and Comparative Examples 14-15, rosin oil and aromatic ND200 appear to be tolerant of different non-ionic surfactants. As shown in Example 16, when the rosin content of the distilled tall oil was 50 wt % or more, stable formulations could be obtained. This is in contrast to the results obtained in Table 2 (Examples 1, 3, 5, and 6).

TABLE 4
Example No.

| Component | Units | E19 | E20 | E21 | E22 |
|---|---|---|---|---|---|
| Bifenthrin | wt % | 25 | 25 | 25 | 25 |
| NS-1 | | 10 | | | 10 |
| NS-2 | wt % | | 10 | 10 | |
| TOFA- | wt % | 65 | | | |
| methyl ester | | | | | |
| SOFA methyl | wt % | | | | 65 |
| ester | | | | | |
| TOFA-butyl | | | 65 | | |
| ester | | | | | |
| TOFA-PE | | | | 65 | |
| ester | | | | | |

Although initially stable, after four freeze/thaw cycles, crystal formation was observed for Examples 19-22 (Table 4). At 25% bifenthrin loading, TOFA butyl ester (Example 20) and TOFA PE ester (Example 21), failed to produce stable formulations unlike TOFA methyl ester (Example 8). Storage performance of formulations using TOFA methyl ester or SOFA methyl ester as solvents can depend on surfactant selection, as seen in Table 4. In Example 19, TOFA methyl ester and non-ionic surfactant (NS-1) resulted in crystal formation after four freeze-thaw cycles, whereas TOFA methyl ester and non-ionic surfactant (NS-2) resulted in a stable formulation (Example 8). Similarly, SOFA methyl ester and non-ionic surfactant (NS-1) (Example 22) resulted in crystal formation after four freeze-thaw cycles, whereas SOFA methyl ester and non-ionic surfactant (NS-2) resulted in a stable formulation (Example 9).

These preliminary experiments indicate suitable solvents for 25 wt % bifenthrin formulations include TOFA-methyl ester, SOFA-methyl ester, rosin oil, aromatic ND200, DTO (50 wt % rosin), polyterpene, rosin methyl ester, methyl ester of hydrogenated rosin, or a combination thereof.

Both the natural oil solvents and the organic solvents were analyzed for VOC and SVOC content using gas chromatography-flame ionization detector (GC-FID) analysis. The parameters of GC-FID used are listed in Table 5. The analysis results are listed in Table 6.

TABLE 5
GC-FID Analysis Conditions

| | |
|---|---|
| Instrument | Shimadzu GC-2010 Plus, GCMS QP2010-SE |
| Column | ZB-5M, 30 m, 0.25 mm ID, 0.25 μm |
| Diluent | MeOH |
| Column temp | 40° C. |

Injection

| | |
|---|---|
| Inj. Vol.: | 1 μL pulsed split 1:20 |
| Inj. Temp. | 320° C. |

Oven

| | |
|---|---|
| Oven Temp. | 50° C. (hold for 1 min) to 310° C. |
| | (hold for 5 min) at 10° C./min |
| Carrier Gas | He, constant flow |

TABLE 6

| Solvent name | VOC (%) | SVOC (%) |
|---|---|---|
| DTO-5 | 0.27% | 0.00% |
| DTO-1 | 0.26% | 0.00% |
| DTO-2 | 0.35% | 0.00% |
| DTO-3 | 0.44% | 0.00% |
| DTO-4 | 0.48% | 0.00% |
| DTO-6 | 0.83% | 0.00% |
| DTO-7 | 0.54% | 0.00% |
| Organic Solvent -1 | 0.23% | 99.77% |
| Organic Solvent -2 | 86.07% | 13.93% |
| SOFA methyl ester | 0.84% | 0.00% |

As shown in Table 6, the distilled tall oils and the SOFA methyl ester contained less than 1% VOC, whereas the organic solvents had high levels of VOC and/or SVOC.

### Examples 23-24

TABLE 7

| Component | Units | E23 | E24 |
|---|---|---|---|
| Tebuconazole | wt % | 25 | 10 |
| Azoxystrobin | wt % | | 5.6 |
| prochloraz | wt % | | 20 |
| GS-1 | wt % | 13 | 21.6 |
| DTO-1 | wt % | | 32.4 |
| DTO-4 | wt % | 52 | |
| Surfom 360 | wt % | 10 | 10 |

Table 7 shows exemplary formulations using a green co-solvent in combination with a natural oil solvent. Example 23 includes loading of 25 wt % in a mixture of DTO-4 (having 28% rosin content) and butyl lactate (GS-1). Example 24 includes 35.6 wt % loading of the active components (Tebuconazole, Azoxystrobin, and Prochloraz) in a mixture of DTO-1 (having 1% rosin content) and butyl lactate (GS-1). Advantageously, the formulations of Examples 23-24 eliminate the use of the undesirable organic solvents by using a mixture of a distilled tall oil as the natural solvent and n-butyl lactate as the green co-solvent.

### EXEMPLARY EMBODIMENTS

In an aspect, the disclosure provides an emulsifiable concentrate formulation comprising an active component, a natural oil solvent, and a non-ionic surfactant. In any of the aspects or embodiments described herein, the active component comprises a pesticide, a fungicide, an herbicide, or a combination thereof. In any aspect or embodiment described herein, the formulation comprises an effective amount of the active component. In any aspect or embodiment described herein, the formulation comprises a natural oil solvent.

In any aspect or embodiment described herein, the solvent has a volatile organic content of up to about 1 wt %. In any aspect or embodiment described herein, the pesticide, when present, is a pyrethroid. In any aspect or embodiment described herein, the pesticide, when present, is bifenthrin.

In any aspect or embodiment described herein, the natural oil solvent is an ester of tall oil fatty acid, C₁-C₅ ester of soybean oil fatty acid, a rosin oil, a rosin C₁-C₃ ester, a distilled tall oil, a C₁-C₃ of a hydrogenated rosin, vegetable oil, safflower oil, sesame oil, canola oil, olive oil, polyterpene, or a combination thereof.

In any aspect or embodiment described herein, the natural oil solvent is a C₁-C₃ ester of tall oil fatty acid, C₁-C₅ ester of a soybean oil fatty acid, a rosin oil, a rosin C₁-C₃ ester, a polyterpene, a C₁-C₃ methyl ester of hydrogenated resin, a distilled tall oil, or a combination thereof.

In any aspect or embodiment described herein, the formulation further comprises an organic solvent.

In any aspect or embodiment described herein, the formulation further comprises a green co-solvent different from the natural oil solvent and when present, the organic solvent, wherein the green co-solvent comprises a C₃-C₈ ketone solvent, a C₁-C₆ alcohol solvent, a C₃-C₈ acetate solvent, a C₄-C₈ lactate solvent, a C₆-C₁₀ levulinate solvent, or a combination thereof.

In any aspect or embodiment described herein, when present, the green co-solvent comprises acetone, methyl ethyl ketone, methyl isobutyl ketone, methanol, ethanol, 1-propanol, 2-propanol, 1-butanol, t-butanol, ethyl acetate, isopropyl acetate, propyl acetate, butyl acetate, isobutyl acetate, t-butyl acetate, methyl lactate, ethyl lactate, propyl lactate, isopropyl lactate, butyl lactate, isobutyl lactate, t-butyl lactate, methyl levulinate, ethyl levulinate, propyl levulinate, isopropyl levulinate, butyl levulinate, isobutyl levulinate, t-butyl levulinate, or a combination thereof.

In any aspect or embodiment described herein, the non-ionic surfactant is an ethylene oxide-co-propylene oxide, castor oil ethoxylate, a polysorbate, nonylphenol ethoxylate, ethoxylated distilled tall oil, or a combination thereof. In any aspect or embodiment described herein, an organic solvent is absent. In any aspect or embodiment described herein, the formulation further comprises an additional surfactant.

In any aspect or embodiment described herein, the active component is a pesticide and comprises up to 25 wt % of the total weight of the formulation. In any aspect or embodiment described herein, the natural oil solvent comprises a distilled tall oil comprising at least 50 wt % rosin, based on the total weight of the distilled tall oil.

In any aspect or embodiment described herein, the formulation comprises up to about 15 wt % bifenthrin; from about 65 to about 80 wt % of a natural oil solvent, wherein the natural oil solvent is an ester of a tall oil fatty acid, C₁-C₅ ester of soybean oil fatty acid, rosin oil, a rosin C₁-C₃ ester, a distilled tall oil, a C₁-C₃ of a hydrogenated rosin, vegetable oil, safflower oil, sesame oil, canola oil, olive oil, a polyterpene, or a combination thereof; and from about 5 to about 20 wt % non-ionic surfactant.

In any aspect or embodiment described herein, the formulation comprises from about 15 to about 30 wt % bifenthrin; from about 50 to about 80 wt % natural oil solvent, wherein the natural oil solvent is a distilled tall oil comprising at least 50 wt % rosin, based on the total weight of the distilled tall oil, a C₁-C₃ ester of a tall oil fatty acid, C₁-C₅ ester of soybean oil fatty acid, rosin oil, a polyterpene, a rosin C₁-C₃ ester, a methyl ester of hydrogenated rosin, or a combination thereof; and from about 5 to about 20 wt % non-ionic surfactant.

In any aspect or embodiment described herein, the formulation further comprises water (the difference to 100 wt %).

In an aspect, the disclosure provides a method of preparing an agricultural formulation comprising admixing an active ingredient, a natural oil solvent, and a non-ionic surfactant; optionally, the green co-solvent; and optionally, the organic solvent; and dissolving the mixture to form a homogenous solution.

What is claimed is:

1. An agricultural formulation comprising:
an active component comprising a pesticide, a fungicide, an herbicide, or a combination thereof;
a natural oil solvent; and
a non-ionic surfactant.

2. The agricultural formulation according to claim 1, wherein the natural oil solvent has a volatile organic content up to about 1 wt %.

3. The agricultural formulation according to claim 1, wherein the pesticide is present and comprises bifenthrin.

4. The agricultural formulation according to claim 1, further comprising an organic solvent comprising a polar aprotic solvent, an aliphatic hydrocarbon, an aromatic hydrocarbon, or a combination thereof.

5. The agricultural formulation according to claim 1, further comprising a green co-solvent different from the natural oil solvent and when present, different from the organic solvent, wherein the green co-solvent comprises a ketone solvent, an alcohol solvent, an organic acid solvent, an acetate solvent, a lactate solvent, a leveulinate solvent, or a combination thereof.

6. The agricultural formulation according to claim 1, wherein the green co-solvent comprises a C₃-C₈ ketone solvent, a C₁-C₆ alcohol solvent, a C₂-C₁₀ carboxylic acid, a C₃-C₈ acetate solvent, a C₄-C₈ lactate solvent, a C₆-C₁₀ levulinate solvent, or a combination thereof.

7. The agricultural formulation according to claim 1, wherein the green co-solvent comprises acetone, methyl ethyl ketone, methyl isobutyl ketone, methanol, ethanol, 1-propanol, 2-propanol, 1-butanol, t-butanol, acetic acid, ethyl acetate, isopropyl acetate, propyl acetate, butyl acetate, isobutyl acetate, t-butyl acetate, methyl lactate, ethyl lactate, propyl lactate, isopropyl lactate, butyl lactate, isobutyl lactate, t-butyl lactate, methyl levulinate, ethyl levulinate, propyl levulinate, isopropyl levulinate, butyl levulinate, isobutyl levulinate, t-butyl levulinate, or a combination thereof.

8. The agricultural formulation according to claim 1, wherein the natural oil solvent is an ester of tall oil fatty acid, C₁-C₅ ester of soybean oil fatty acid, a rosin oil, a rosin C₁-C₃ ester, a distilled tall oil, a C₁-C₃ of a hydrogenated rosin, vegetable oil, safflower oil, sesame oil, canola oil, olive oil, polyterpene, or a combination thereof.

9. The agricultural formulation according to claim 1, wherein the natural oil solvent is a C₁-C₃ ester of tall oil fatty acid, C₁-C₅ ester of a soybean oil fatty acid, a rosin oil, a rosin C₁-C₃ ester, a polyterpene, a C₁-C₃ methyl ester of hydrogenated resin, a distilled tall oil, or a combination thereof.

10. The agricultural formulation according to claim 1, wherein the non-ionic surfactant is an ethylene oxide-co-propylene oxide, castor oil ethoxylate, a polysorbate, nonylphenol ethoxylate, ethoxylated distilled tall oil, or a combination thereof.

11. The agricultural formulation according to claim 1, wherein an organic solvent is absent.

12. The agricultural formulation according to claim 1, further comprising an additional surfactant.

13. The agricultural formulation according to claim 1, wherein the active component is a pesticide comprising up to about 25 wt % of the total weight of the formulation.

14. The agricultural formulation according to claim 1, wherein the natural oil solvent comprises a distilled tall oil comprising at least about 50 wt % rosin, based on the total weight of the distilled tall oil.

15. The agricultural formulation according to claim 1 comprising
up to about 45 wt % of the active component;
about 20 to about 60 wt % of the natural oil solvent comprising a tall oil fatty acid, a distilled tall oil, vegetable oil, safflower oil, sesame oil, canola oil, olive oil, or a combination thereof; and
about 5 to about 30 wt % of the green co-solvent comprising butyl lactate.

16. The agricultural formulation according to claim 1 comprising
up to about 15 wt % bifenthrin as the active component;
from about 65 to about 80 wt % solvent comprising a natural oil solvent, wherein the natural oil solvent is an ester of a tall oil fatty acid, C₁-C₅ ester of soybean oil fatty acid, rosin oil, a rosin C₁-C₃ ester, a distilled tall oil, a C₁-C₃ of a hydrogenated rosin, vegetable oil, safflower oil, sesame oil, canola oil, olive oil, a polyterpene, or a combination thereof; and
from about 5 to about 20 wt % non-ionic surfactant.

17. The agricultural formulation according to claim 1 comprising
from about 15 to about 30 wt % bifenthrin;
from about 50 to about 80 wt % solvent comprising a natural oil solvent, wherein the natural oil solvent is a distilled tall oil comprising at least 50 wt % rosin, based on the total weight of the distilled tall oil, a C₁-C₃ ester of a tall oil fatty acid, C₁-C₅ ester of soybean oil fatty acid, rosin oil, a polyterpene, a rosin C₁-C₃ ester, a methyl ester of hydrogenated rosin, or a combination thereof; and
from about 5 to about 20 wt % non-ionic surfactant.

18. The agricultural formulation according to claim 14, further comprising an organic solvent.

19. The agricultural formulation according to claim 1, further comprising water.

20. A method of preparing an agricultural formulation of claim 1 comprising:
admixing the active component, the natural oil solvent, the non-ionic surfactant, optionally, the green co-solvent; and optionally, the organic solvent; and
dissolving the mixture to form a homogenous solution.
